(19) United States
(12) Patent Application Publication
(10) Pub. No.: US 2015/0226876 A1
(43) Pub. Date: Aug. 13, 2015

(54) SYSTEM FOR DETECTING A GENERALLY TRANSPARENT OR TRANSLUCENT ITEM

(71) Applicants: Joel Donald GRAY, Barrington, IL (US); Robert Michael GRAY, Chicago, IL (US); Jeffrey J. DEAN, Hampshire, IL (US)

(72) Inventors: Joel Donald GRAY, Barrington, IL (US); Robert Michael GRAY, Chicago, IL (US); Jeffrey J. DEAN, Hampshire, IL (US)

(21) Appl. No.: 14/493,580

(22) Filed: Sep. 23, 2014

Related U.S. Application Data
(60) Provisional application No. 61/939,096, filed on Feb. 12, 2014.

(51) Int. Cl. G01V 8/12

(52) U.S. Cl. CPC G01V 8/12; G01N 2201/061

(57) ABSTRACT

A detector for detecting generally transparent or translucent items for a high speed filling machine. The detector includes an infrared emitter emitting infrared light in a range of 1300 nm to 1600 nm or 1800 nm to 2200 nm and an infrared sensor for detecting infrared light in the selected ranges.

### CROSS REFERENCE TO RELATED APPLICATION

This Application claims the benefit of U.S. Provisional Patent Application Ser. No. 61/939,096, filed 12 Feb. 2014, which is incorporated herein by reference.

### BACKGROUND OF THE INVENTION

1. Field of the Invention

This invention relates to a system and apparatus for detecting and/or inspecting items. More specifically, this invention relates to a system and apparatus for detecting and/or inspecting generally transparent or translucent items, such as soft gels, pills, tablets, and capsules.

2. Description of Prior Art

Industries, such as pharmaceutical and food supplements, generally package their soft gels, pills, tablets, caplets and other similar small items using high speed filling machines, such as slat fillers, rotary slat fillers and other similar machines. These machines operate at very high speeds and can be prone to over-filling or under-filling a bottle or package. To prevent such errors, known filling machines often use optical inspection systems to maintain a proper count and to make sure the packages are filled with the proper number of pills. While known optical inspection systems work well with opaque pills and tablets, these known systems are unable to detect transparent, translucent or partially transparent or translucent pills, tablets and caplets, such as soft gels. Hereinafter “transparent” and/or “translucent” are intended to mean any soft pill, tablet, caplet and any other item that permits at least some light to pass through either entirely or in a diffused manner. Entirely opaque objects are not included in this definition. These known optical counters rely on the pills, tablets and caplets blocking light from a light source from reaching a sensor. Many transparent or translucent items cannot block or sufficiently refract the light source, allowing the light to reach the sensor and not be counted by the optical counter. Other known counting systems rely on secondary optical systems that visually compare good and bad tablets. However, these visual systems can be very expensive. As such, there is a need for a simple, inexpensive system for reliably detecting transparent and/or translucent products, such as soft gels or capsules.

### SUMMARY OF THE INVENTION

A general object of this invention is to provide a detector for a high speed filling machine for filling a bottle or similar package with a plurality of small items, such as soft gels, pills, caplet, tablets or similar small items. The detector of this invention is capable of detecting and/or counting generally transparent and/or translucent items that cannot be detected with known optical sensor based counters. For ease of explanation, the following description will refer to soft gels, pills, caplets and/or tablets. However, it should be understood that other generally transparent and/or translucent items may be detected with the device of this invention, including items which are not pharmaceutical items and/or items which are not ingested orally.

According to a preferred embodiment of this invention, the detector of this invention is a device that determines whether the item to be detected is present in a position of a machine such as a slat filler, a rotary filler or another similar filler. For example, whether the item to be detected is positioned in a cavity between slats of a slat filler. The subject invention preferably relies upon infrared through beam technology to establish the presence or absence of the item, such as a soft gel. The system will detect if the item is absent and reject the bottle being filled from a production line, if necessary.

In a preferred embodiment of this invention, the detector includes a sensing head positioned on the filling machine with a light head positioned in proximity to and aligned with the sensing head to allow the item to pass between the light head and the sensing head. The light head emits infrared light with a target wavelength. In a preferred embodiment, because the translucent tablets and soft gels generally contain a water based gel, the target wavelength is selected to coincide with the absorption coefficient of water and lies in ranges of 1300 nm to 1600 nm or 1800 nm to 2200 nm. This allows the water in the translucent tablets and soft gels to absorb and block the infrared light whereas light at other wavelengths would pass through. However, other wavelengths of the light spectrum may be used as long as the wavelength is sufficiently blocked or refracted by the soft gel or other items being detected. In a preferred embodiment, the sensing head includes a sensor that is capable of detecting infrared light with the target wavelength. In an embodiment of this invention, the detector includes an Indium Gallium Arsenide (InGaAs) based system of sensors and/or emitters. The InGaAs sensor is preferably capable of detecting infrared light with a wavelength ranging from 1300 nm to 1600 nm and/or 1800 nm to 2200 nm. In one embodiment the InGaAs based system is capable of detecting infrared light with a wavelength of 1450 nm or greater. In alternative embodiments, other light emitters and sensors operating in other wavelengths of the light spectrum may be used. For example, other embodiments may use silicon based system of emitters and detectors.

In operation, the soft gel in the filling machine passes between the light head and the sensing head and blocks, absorbs or refracts the infrared light in the target wavelength emitted from the light head to prevent the infrared light from reaching the sensing head, thereby indicating the slat cavity is full. If the light reaches the sensor, it indicates that the slat cavity is empty, triggering the system to reject the bottle with the missing tablet.

In an embodiment of this invention, the item being detected comprises a soft gel or capsule which appears generally transparent and/or translucent in the visible spectrum but, because of water in the gelatin coating or another part of the soft gel, the soft gel appears opaque in the infrared spectrum and blocks the target wavelength. Alternatively, the item is capable of refracting, rather than absorbing, the wavelength of light from the emitter o prevent detection by the sensor.

### BRIEF DESCRIPTION OF THE DRAWINGS

In the detailed description that follows, reference will be made to the following figures:

FIG. 1 is an exploded assembly view of a sensing head of a detector according to one preferred embodiment of this invention.

FIG. 2 is an exploded assembly view of a light head of the detector according to one preferred embodiment of this invention.

FIG. 3 is an isometric view of a filling machine with an embodiment of the detector of this invention.

FIG. 4 is a front view of the filling machine of FIG. 3.

FIG. 5 is a side view of the filling machine of FIG. 3.

FIG. 6 is a side isometric view of the filling machine of FIG. 3 with portions removed to show the sensing heads and light heads.

FIG. 7 is a front view of the filling machine of FIG. 3 with a bottling machine.

FIG. 8 is a graph showing the absorption coefficient of water.

### DETAILED DESCRIPTION OF THE INVENTION

The subject invention is directed to an apparatus for detecting generally transparent and/or translucent pharmaceutical and vitamin supplement items, such as soft gels, caplets, pills, tablets or capsules. However, the subject invention but may be used with other transparent and non-transparent items which require detecting during packaging and other procedures.

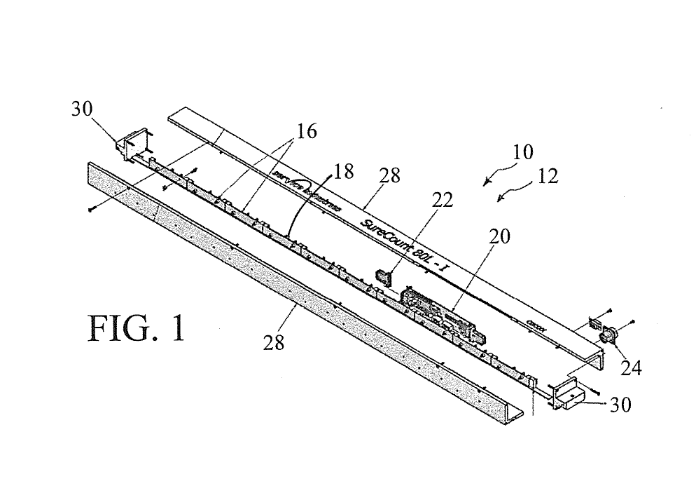

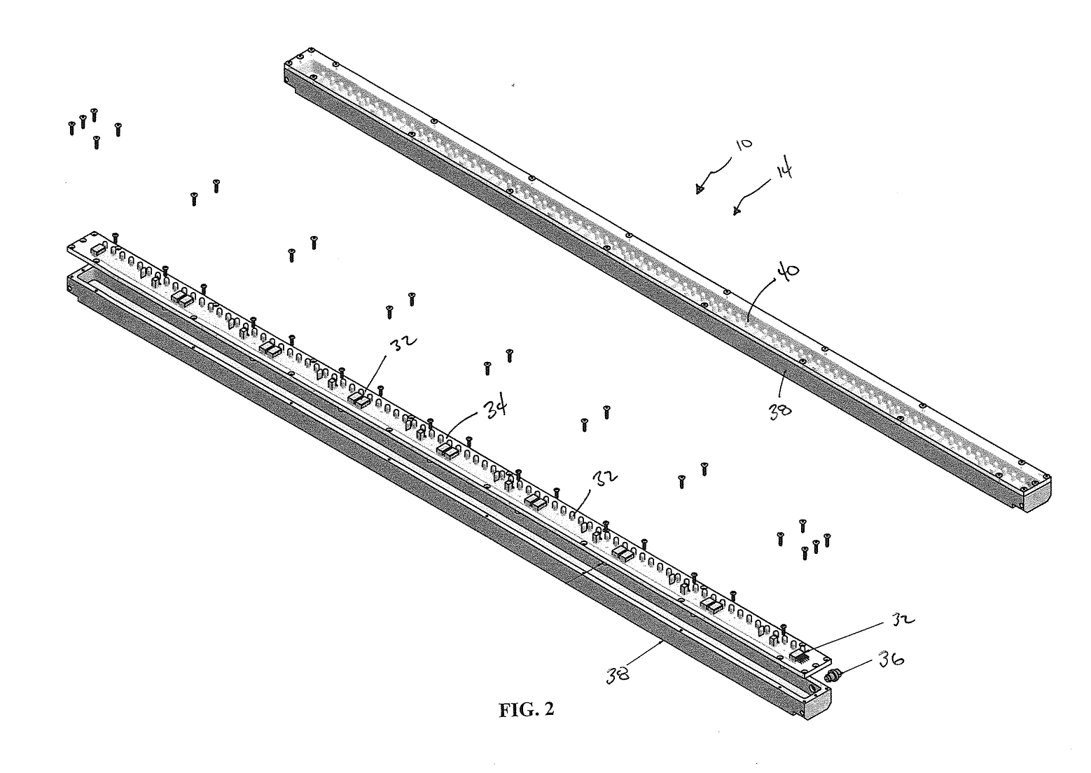

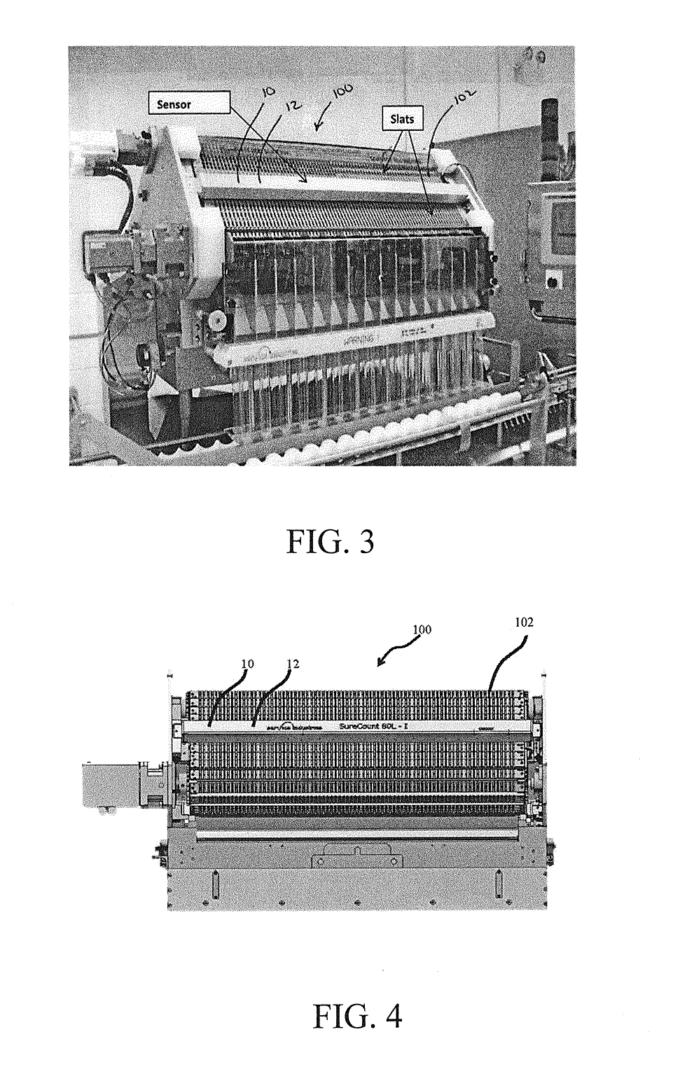

FIGS. 1 and 2 illustrate two primary components of a detector 10 for a filling machine according to an embodiment of this invention. FIG. 3 shows the detector 10 of FIGS. 1 and 2 attached to a slat filling machine 100. The slat type filling machine 100 is one type of filling machine and it should be noted that the filling machine need not be a slat-type filling machine and may comprise any type of machine which is used to rapidly count and package items in a bottle or other package. For ease of explanation, the following description will be directed to slat-type filling machines.

The detector 10 of an embodiment of this invention comprises a sensing head 12, shown in FIG. 1, and a light head 14, shown in FIG. 2. This two-piece design works well with the slat type filling machine 100, however the sensing head 12 and the light head 14 need not have this design and may comprise another shape or design depending on the type of filling machine used. For example, the detector 10 may comprise a one-piece design with both the sensing head and light head on a single body. One important consideration is to align the sensing head 12 and the light head 14 to take advantage of through beam technology to establish the presence or absence of the generally transparent or translucent item.

FIG. 1 shows the sensing head 12 in an exploded assembly view to illustrate components of this embodiment. In this embodiment, the sensing head 12 includes a plurality of sensors 16 mounted on a sensor board 18 and electrically connected to and controlled by a sensor controller 20. The sensor controller 20 preferably further includes connector 22 for a power supply, not shown, and a port 24 for programming and/or debugging the controller 20 or sensors 16. The sensor controller 20 is preferably connected to a processor, not shown, or a computer for processing data gathered by the sensor, detecting the presence of the item, calculating a count or otherwise using the data. The sensing head 12 may further includes a sensor lens, not shown, and a housing 28, and a mounting bracket 30. The sensor lens focuses an infrared light from the light head 12 and protects the sensors 16. Alternatively, the lens may not focus the infrared light and may only protect the sensors 16. The housing 28 supports and at least partially encloses the sensors 16, the board 18 and the controller 20.

FIG. 2 shows the light head 14 in an exploded assembly view to illustrate components of this embodiment. In this embodiment, the light head 14 includes a plurality of emitters 32 mounted to a light board 34 and a light connecter 36 connected to a power supply, not shown, to provide power to the emitters 32. The light connector may further be connected to a processor, not shown, to process data and/or control the emitters. The emitters 32 are preferably selected to provide infrared light with a target wavelength in a range of 1300 nm to 1600 nm and/or 1800 nm to 2200 nm. Alternatively, the emitters 32 can be designed to provide light with any wavelength on the light spectrum. The light head 14 preferably further includes a light housing 38 and a lens 40. The lens 40 protects the emitters 32 and may or may not focus the infrared light from the emitters 32.

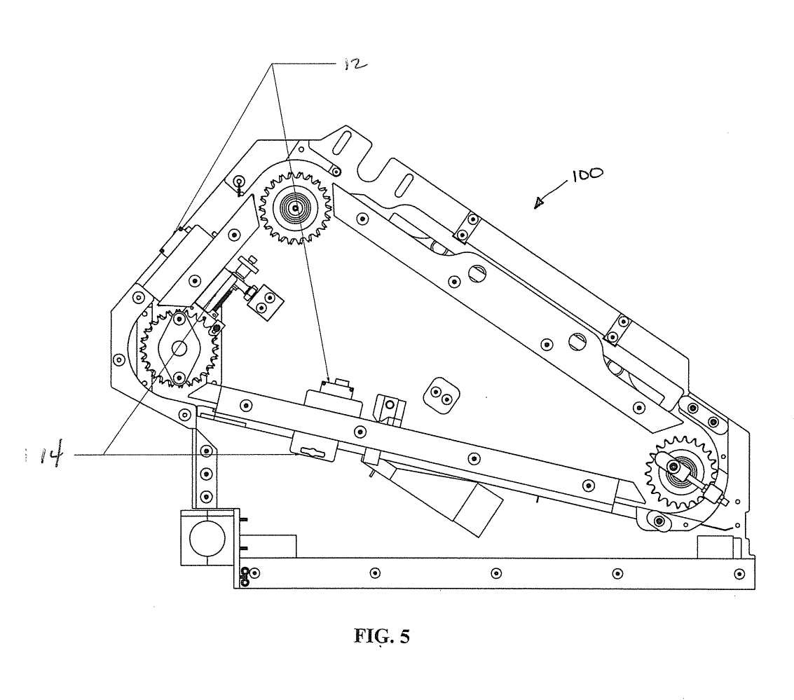

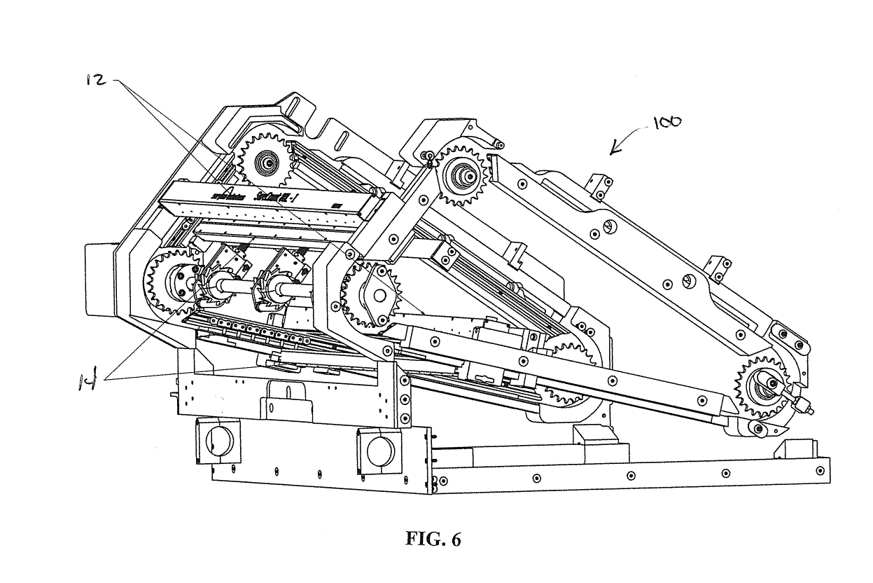

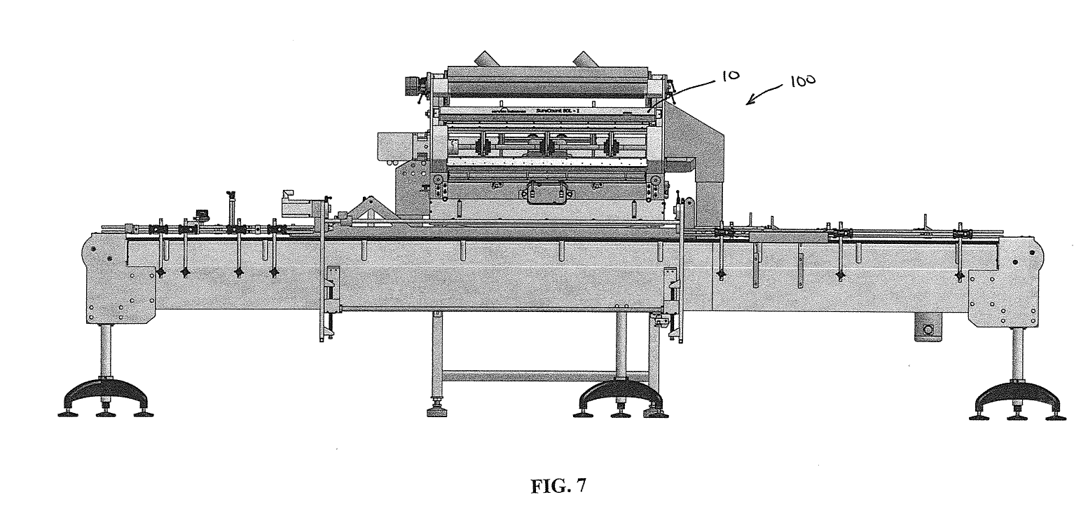

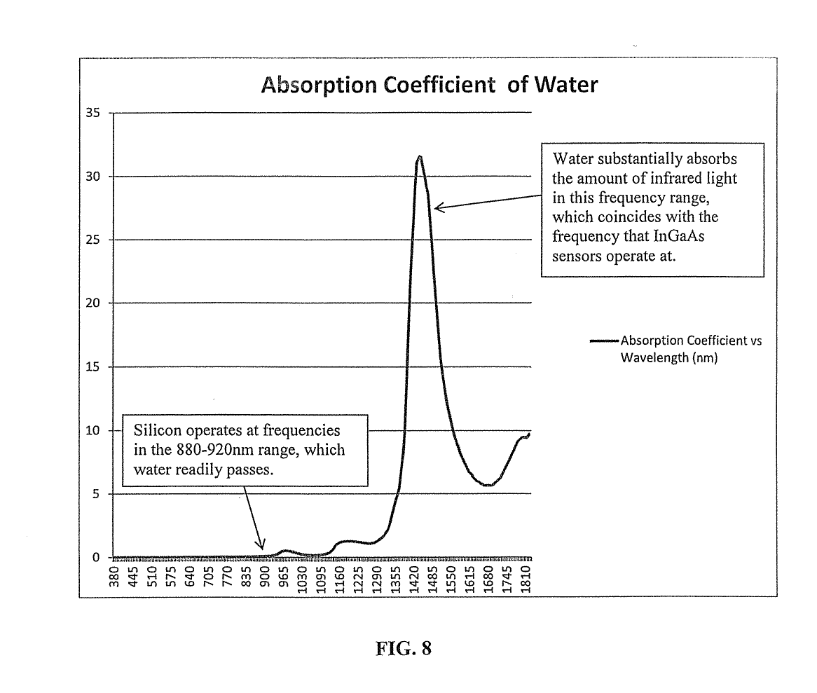

As shown in the preferred embodiment of FIGS. 3-7, the detector 10 of this invention is mounted to the slat filling machine 100. In this embodiment, two sets of detectors 10 are mounted to the slat filling machine 100. The sensing head 12 is preferably mounted above slats 102 on an exterior of the slat filling machine 100. The sensing head 12 acts as a receiver for the infrared light from the light head 14 when there is no soft gel present in a cavity. There is preferably one sensor for every cavity in the slats. Alternatively, a plurality of cavities may be positioned in a row within each slat, and the sensor monitors the row of cavities in each slat. The light head 14 is preferably mounted below the slats 102 on the interior of the machine 100. The light head 14 preferably houses the individual infrared emitters and emits light for the sensing head 12 to receive when there is no soft gel present in the cavity. More generally, the light head 14 is preferably mounted opposite to and aligned with the sensing head 12 such that the soft gel to be inspected/counted passes between.

Known optical detection systems utilize silicon based light emitters and sensors that operate in 880-920 nm range of the infrared spectrum. This range works well for opaque items, however transparent items pose a challenge as light at this wavelength can typically pass through transparent and/or translucent materials. In the invention of this application, it was determined that a longer wavelength of infrared light is blocked by the water molecules that are inherent in gelatin material of generally transparent items, such as a coating on soft gel capsules. As shown in FIG. 8, water absorbs infrared light at wavelengths ranging generally from 1300 nm to 1600 nm. Water also absorbs infrared light at wavelengths ranging from 1800 nm to 2200 nm. As such, soft gels, especially with a water containing gelatin coating, and other generally transparent tablets containing water also absorb light with wavelengths of 1300 nm to 1600 nm and 1800 nm to 2200 nm. By using light with a wavelength in the ranges mentioned above, the detection system of this invention can reliably detect soft gels and other similar transparent capsules, tablets, or other products containing water. In one preferred embodiment of this invention, the detector 10 utilizes a sensor and an emitter based on a wavelength of 1450 nm. This selected target wavelength of infrared light can be preferably emitted and detected using InGaAs (Indium Gallium Arsenide) based sensors and/or emitters. InGaAs components are preferred because an InGaAs composition can be adjusted cover a range of wavelengths on the light spectrum. In addition, the detector 10 of this invention with InGaAs components may be used to detect opaque tablets in addition to the transparent and/or translucent tablets, eliminating the need for two separate systems for transparent and opaque tablets. In an alternative embodiment, silicon based technology may be used.

In operation, a plurality of items, such as soft gels, are loaded in a hopper and deposited on the slats 102 of the slat filling machine 100. The filling machine 100 preferably includes a vibrator or another similar device to assist the tablets into the slats 102. The slats 102 are preferably designed so that only one tablet fits between each of the slats 102 and into a cavity 106 positioned below the slats 102. The cavities 106 each include an aperture which is smaller than the tablet. The cavities are transported on a belt, chain or other similar device along the filling machine 100 and between the sensing head 12 and the light head 14 of the detector 10. In a preferred embodiment, one emitter 32 and one sensor 16 are aligned with each cavity such that the infrared light of the target wavelength passes through the aperture and the cavity. If the infrared light intersects an item in the cavity, water in the item absorbs the infrared light preventing the infrared light from reaching and being detected by the sensor 16 triggering the detection or a count of the item. If the cavity does not contain the item, the infrared light passes through the aperture and the cavity and is detected by the sensor 16 indicating an absence of the item. In an alternative embodiment, one emitter 32 and one sensor 16 are aligned with a plurality of cavities aligned in a row between the slats to monitor the plurality of cavities. Positive and negative data is processed by the controller 20 or another processor to allow the system of this invention to take appropriate action. After passing through the detector 10, the item is packaged in a bottle or another similar package.

This technology was initially developed on a slat filler for detecting filled and empty slat cavities, but could be used on other types of bottle fillers, or other uses where detecting a transparent or translucent product is required.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A detector of an item for a filling machine comprising:
a light head connected to the filling machine, the light head including an emitter to emit a target wavelength of infrared light in a range of one of 1300 nm to 1600 nm and 1800 nm to 2200 nm; and
a sensing head positioned on the filling machine in proximity to the light head, the sensing head including a sensor to detect infrared light in the target wavelength, and wherein the item in the filling machine passes between the light head and the sensing head and the item blocks the infrared light emitted from the light head from reaching the sensing head to detect the item.

2. The detector of claim 1, wherein the item is a generally transparent item.

3. The detector of claim 2, wherein the generally transparent item comprises a soft gel.

4. The detector of claim 1, wherein the sensor comprises an InGaAs sensor.

5. The detector of claim 1, wherein the target wavelength is 1450 nm.

6. The detector of claim 1, wherein the target wavelength is 1550 nm.

7. The detector of claim 1, wherein the filling machine comprises a slat filler.

8. The detector of claim 7, wherein the filling machine includes one sensor and emitter per a cavity in the slat filler.

9. The detector of claim 7, wherein each slat of the slat filler includes a plurality cavities and the sensor and the emitter are aligned with the plurality of cavities.

10. The detector of claim 1, wherein the sensing head and the light head are connected as a single unit.

11. A detector for a filling machine comprising:
a sensing head positioned on a the filling machine, the sensing head including a sensor to detect infrared light with a target wavelength, wherein the target wavelength comprises a wavelength greater than 1300 nm; and
a light head positioned in proximity to the sensing head to allow an item to pass between the light head and the sensing head, wherein the light head emits infrared light at the target wavelength and the item blocks the infrared light emitted from the light head from reaching the sensing head to detect the item.

12. The detector of claim 11, wherein the item comprises a generally transparent item.

13. The detector of claim 12, wherein the tablet comprises one of a soft gel and a capsule.

14. The detector of claim 11, wherein the sensor comprises an InGaAs sensor.

15. The detector of claim 11, wherein the filling machine comprises a slat filler.

16. The detector of claim 15, wherein the filling machine includes one sensor and one emitter per a cavity in the slat filler.

17. The detector of claim 11, wherein the target wavelength is 1450 nm.

18. The detector of claim 11, wherein the target wavelength is 1550 nm.
